(19) United States
(12) Patent Application Publication
(10) Pub. No.: US 2022/0366581 A1
(43) Pub. Date: Nov. 17, 2022

(54) Generation of a Formulation for a Coating Which Matches the Optical Properties of a Target Coating Comprising Effect Pigments

(71) Applicant: BASF COATINGS GMBH, Münster (DE)

(72) Inventors: Amelie PERISSE, Clermont de l'Oise Cedex (FR); Marion L AOT, Clermont de l'Oise Cedex (FR); Thomas KANTIMM, Münster (DE); Guido BISCHOFF, Münster (DE); Eva-Kathrin SCHILLINGER, Münster (DE); Belkacem OTAZAGHINE, Alès (FR); Dominique LAFON PHAM, Alès (FR)

(21) Appl. No.: 17/755,352

(22) PCT Filed: Oct. 28, 2020
(86) PCT No.: PCT/EP2020/080330

§ 371 Date: Apr. 27, 2022

(30) Foreign Application Priority Data
Oct. 30, 2019 (EP) 19290111.4

(51) Int. Cl. G06T 7/44; G01J 3/46; G01J 3/50; H04N 9/64; G06T 7/60

(52) U.S. Cl. CPC G06T 7/44; G01J 3/463; G01J 3/504; H04N 9/64; G06T 7/60; G06T 2207/10024

(57) ABSTRACT

Disclosed herein is a computer-implemented method for generating a coating formulation that yields a coating which is, to the eye of a human observer, identical or substantially similar in appearance to a target coating, as well as a device for performing the method.

### FIELD OF THE INVENTION

The present disclosure relates to a computer-implemented method for generating a coating formulation that yields a coating which is identical or substantially similar in appearance to a target coating, as well as a device for performing the method.

### BACKGROUND

EP 2 728 342 B1 discloses a hand-held measurement device for appearance analyses includes a measurement array which comprises a number of illumination means for applying illumination light to a measurement field in at least three illumination directions and a number of pick-up means for capturing the measurement light in at least one observation direction. The illumination directions and the observation directions lie in a common system plane. At least one pick-up means is embodied to spectrally gauge the measurement light in a locally integral way, and at least one imaging pick-up means is embodied to gauge the measurement light in terms of colour in a locally resolved way.

EP 2 161 555 B1 teaches a method for creating a database for paint colors having a desired texture. The method includes storing spectral reflectance data and micro-brilliance data of paint colors after associating each spectral reflectance data and each micro-brilliance data with a paint color code; storing texture evaluation values of sample paint colors after associating the each texture evaluation value with the paint color code; calculating characteristic quantities of the paint colors expressing textures using the spectral reflectance data and the micro-brilliance data, and storing the characteristic quantities after associating the each characteristic quantity with the paint color code; training a neural network using the characteristic quantities and the texture evaluation values of the sample paint colors as training data; and inputting characteristic quantities of the paint colors other than the sample paint colors into the neural network after the training, and storing output data after associating each output data with the paint color code.

WO 2014/047296 A1 discloses a computer implemented method which includes performing at least one of a visual evaluation and an instrument measurement of a target coating on a target sample to generate colorimetric information, and identifying, using a processor, a bulk toner that is present in the target coating by determining a color and a color intensity at different viewing angles relative to the target sample. The method also includes identifying, using the processor, at least one specific toner that is present in the target coating by detecting a presence and an orientation of colored and/or non-colored pigmentation effects that are present in the target coating, and outputting, using the processor, a formulation of the target coating that includes at least the at least one specific toner.

US 2018/0144505 A1 discloses a computer implemented method involving an analysis of multiple images obtained at different angles with respect to a surface of a target coating using an image capturing device. The method involves using a filtering technique to perform the image analysis on the obtained images to determine the presence of sparkle points within the images. A color attribute analysis can then be performed to determine various color attributes associated with the determined sparkle point. A sparkle color distribution can then be calculated in response to the color attribute analysis. A coating formulation can then be generated, in association with the calculated sparkle color distribution, which is the same or substantially similar to the target coating.

US 2011/246087 A1 discloses a method for automatic selection of colorants and flakes to produce one or more matching formulas to match color and appearance of a target coating containing flakes, and a system for automatic selection of colorants and flakes for producing one or more matching formulas to match color and appearance of a target coating. The method comprises the steps of: a) obtaining appearance data of the target coating; b) comparing the appearance data with appearance characteristics of known flakes stored in a flake database; c) selecting from said flake database, one or more matched flakes, flake combinations or flake ratios that have appearance characteristics matching said appearance data; d) obtaining color data of the target coating; e) comparing said color data with color characteristics of one or more colorant combinations of known colorants stored in a color database to select from said color database, one or more colorant combinations that have color characteristics matching said color data; f) determining colorant concentrations of each said known colorant of said colorant combinations and said flake concentrations of each of the match flakes, the flake combinations or the flake ratios; and g) producing said one or more matching formulas according to said colorant concentrations and said flake concentrations, wherein match coatings resulted from said matching formulas have color characteristics matching the color data and appearance characteristics matching the appearance data.

### SUMMARY OF THE INVENTION

The present disclosure provides a computer-implemented method for generating a coating formulation that yields a coating which is, to the eye of a human observer, identical or substantially similar in appearance to a target coating. The method involves obtaining images of the target coating using an image capturing device, identifying sparkle points within the target coating by performing an image analysis of the obtained images, determining texture attributes of the target coating using the results of the image analysis, and using the texture attributes determined to generate a coating formulation that yields a coating which is, to the eye of a human observer, identical or substantially similar in appearance to the target coating. In the method of the present disclosure, the texture attributes comprise a contrast, a sparkle intensity, a sparkle quantity and a sparkle size of the target coating. In an embodiment of the method, RGB images obtained by the image capturing device are converted into XYZ images; and a high-pass filter is applied to the Y component of the

XYZ images. The high-pass filter has a threshold which corresponds to the contrast sensitivity and the power of discernibility of the human eye.

The present disclosure also provides a system comprising means for generating a coating formulation that yields a coating which is, to the eye of a human observer, identical or substantially similar in appearance to a target coating. The system comprises a database comprising texture attributes and reflectance curves and CIELab values of a plurality of known coatings; and a processor programmed for communication with the database. The processor is programmed for obtaining multiple images of a target coating, performing an image analysis of the obtained images to determine at least one sparkle point within the images, performing a texture analysis to determine texture attributes of the target coating, and generating, in association with the determined texture attributes, a coating formulation that yields a coating which is, to the eye of a human observer, identical or substantially similar in appearance to the target coating. The texture attributes comprise a contrast, a sparkle intensity, a sparkle quantity and a sparkle size of the target coating. In an embodiment of the system, the processor is programmed for converting RGB images obtained by the image capturing device into XYZ images; and for applying a high-pass filter to the Y component of the XYZ images. The high-pass filter has a threshold which corresponds to the contrast sensitivity and the power of discernibility of the human eye.

The present disclosure also provides a non-transitory computer readable medium comprising software for causing a processor to obtain multiple images of a target coating, perform an image analysis on the obtained images to determine at least one sparkle point within the images, perform a texture analysis to determine texture attributes associated with the target coating; and generate, in association with the determined texture attributes, a coating formulation that yields a coating which is, to the eye of a human observer, identical or substantially similar in appearance to the target coating. The texture attributes comprise a contrast, a sparkle intensity, a sparkle quantity and a sparkle size of the target coating. An embodiment of the software causes the processor to convert RGB images obtained by the image capturing device into XYZ images; and to apply to the Y component of the XYZ images a high-pass filter which has a threshold corresponding to the contrast sensitivity and the power of discernibility of the human eye.

### BRIEF DESCRIPTION OF THE DRAWINGS

FIG. 1 is a diagram illustrating the determination of texture attributes of a target coating from images of the coating according to an embodiment of the method of the present disclosure;

FIG. 2 is a flow chart of an embodiment of the method of the present disclosure.

### DETAILED DESCRIPTION

The present disclosure provides a computer-implemented method, comprising:
obtaining, using an image capturing device, multiple images each obtained at a different angle with respect to a surface of a target coating;
performing, using an electronic computer processor in operative association with at least one filtering technique, an image analysis of the obtained images to determine at least one sparkle point within the images;
performing, using the processor, a texture attribute analysis to determine texture attributes of the target coating; and
generating, using the processor and in association with the determined texture attributes, a coating formulation that yields a coating which is, to the eye of a human observer, identical or substantially similar in appearance to the target coating.

The method is characterized in that the texture attributes comprise a contrast, a sparkle intensity, a sparkle quantity and a sparkle size of the target coating.

Complex coatings mixtures comprise effect pigments which lead to optical properties according to their nature. The texture effect enhanced by these particles can be defined by different parameters. According to the present disclosure, the texture effect can be described in terms of the size of the visible sparkling dots, the intensity of the visible sparkling dots, the quantity of sparkling dots and also the contrast between the sparkling dots and the masstone color. These four parameters are referred to as texture attributes in the present disclosure.

These four texture attributes allow for a better description of the visual appearance of coatings prepared from complex coatings mixtures than the one known in the prior art, which only uses the distribution of the size of the visible sparkling dots. By also considering the sparkling dots quantity distribution, the sparkling dots intensity distribution, and the contrast value in addition to the sparkle size determination and the CIELab values, a search in a database of known coating formulations can yield much better results. And a coating formulation can be generated which yields a coating closely matching visual appearance of a target coating to the eye of a human observer.

All four texture attributes can be determined using an image capturing device which obtains multiple images of the target coating at different angles, for instance, the device disclosed in EP 2 728 342 B1.

In a further embodiment of the method, multiple reflectance curves each obtained at a different angle with respect to the surface of the target coating are also obtained using a spectrophotometer.

In a further embodiment of the method, CIELab coordinates of the target coating are also obtained.

In an embodiment of the method, the images obtained with the image capturing device are RGB images and comprise images of the surface illuminated by direct light and images of the surface illuminated by diffuse light; and the image analysis comprises conversion of the RGB images into XYZ images; and analysis of the Y component of the XYZ images to determine at least one sparkle point within the images. In one embodiment of the method, the RGB pictures are converted into XYZ pictures by calibration of the spectrophotometer, and only the Y component of the XYZ pictures is considered, as it is close to the luminance value.

In a further embodiment of the method, the filtering technique used in the image analysis includes applying a high-pass filter to the Y component of the XYZ images, the high-pass filter having a threshold which corresponds to the contrast sensitivity and the power of discernibility of the human eye.

In an embodiment of the method, the size of the visible sparkling dots is determined using an adaptative threshold value on the images in order to better correlate the results to the perception of the human visual system. The threshold value is based on the sensitivity of the human eye and its power of discernibility of small elements. This adaptative threshold value is determined from a comparison of visual assessments of coatings samples by trained observers.

The texture attribute “contrast” is the basis for determining the three other texture attributes. Contrast can be explained as the difference in luminance between two objects which makes them discernible from each other. It is necessary to identify what is visible (foreground) and what is not visible (background) in the image. The threshold separating the foreground from the background is determined by considering the contrast sensitivity and the power of discernibility of the human eye. A high-pass filter having this threshold is then applied to the image, and only the foreground, i.e., the visible part is evaluated in the picture analysis.

In one embodiment of the method, an image of the surface of the target coating illuminated by diffuse light is analyzed to determine a contrast coefficient C. A luminosity histogram (number of pixels for each luminosity value) of the image is prepared, i.e., a histogram of the Y component of the XYZ image. Linear regression is performed to fit the obtained data to the sensitivity of the human eye and its power of discernibility of small elements. The maximum luminosity (MAX) and the minimum luminosity (MIN) of the image are determined. A threshold value (THRESHOLD) corresponding to the contrast sensitivity and the power of discernibility of the human eye is set to separate the background of the image from the foreground. The background of the image comprises the pixels with luminosities in the interval [MIN; THRESHOLD] and the foreground comprises the pixels with luminosities in the interval ]THRESHOLD; MAX]. Mean luminosity values for the foreground (MEAN_{FG}) and the background (MEAN_{BG}), respectively, are calculated. A weighted sum of the luminosity values for the foreground (WS_{FG}) and the background (WS_{BG}), respectively, are also calculated. The weighted sum is obtained by multiplying each luminosity value with the number of pixels having that luminosity value and adding up the terms. The contrast coefficient C corresponds to the formula

$$C = \frac{log ( \frac{{MEAN}_{FG} / {MEAN}_{BG}}{\vert log ( {WS}_{FG} / {WS}_{BG} ) \vert} )}{\sqrt{MAX - MIN}}$$

The contrast can be modified by changing the background color (a darker background will increase the contrast perception and vice versa) or by changing the particles (smaller particles will tend to a lower contrast as it is less easy to see them), but in that case the size parameter must be taken into account.

For determining the sparkle size coefficient S, the following formula is used:

$$S = ( \frac{\sqrt{MEAN}}{{{SLOPE}_{2}}^{2}} )$$

The slope (SLOPE₂) of the sparkle size distribution is determined using initial filtering in order to remove objects which are smaller in size than the structuring elements. In this case, the structuring element is a square of size 2×2 pixels. The relative loss in pixels calculated for the area remaining after the initial filtering operation allows for the slope determination.

For the determination of the sparkle quantity coefficient Q, the following formula is used:

$$Q = \sqrt{\frac{Number of pixels in the foreground}{ln ( S )}}$$

The assumption made here is that the perceived apparent size of effect particles has a non-negligible effect on the visible quantity of effect particles. This is why the size coefficient S is taken into account in the quantity coefficient Q.

For determining the sparkle intensity coefficient I, the following formula is used:

$$I = log ( \frac{\sqrt{MAX - MIN}}{MEAN} \times {MEAN}_{FG} \times {ln ( S )}^{2} )$$

The assumption made here is that the perceived apparent size of effect particles has a non-negligible effect on the visible intensity of effect particles. This is why the size coefficient S is taken into account in the intensity coefficient I.

The maximum luminosity (MAX), the minimum luminosity (MIN), and the mean luminosity (MEAN) of the entire image are determined; and statistical evaluations are performed on the foreground to define the mean luminosity value of the foreground (MEAN_{FG}).

In one embodiment, the method includes comparing, using the processor, the texture attributes of the target coating to texture attributes of a plurality of known coatings stored in a database, and searching for a closest match.

In a further embodiment, the method additionally includes comparing, using the processor, reflectance curves of the target coating to reflectance curves of a plurality of known coatings stored in a database, and searching for a closest match.

In a further embodiment, the method additionally includes comparing, using the processor, CIELab values of the target coating to CIELab values of a plurality of known coatings stored in a database, and searching for a closest match.

In an embodiment of the method, a sparkle size distribution, a sparkling dots quantity distribution, a sparkling dots intensity distribution and a contrast value are determined and compared to the texture attributes of known coatings by a database search. The texture attributes determined from the images and the colorimetric data of the target coating are then compared to the results of the search. If all parameters are close to the target parameters, the formula yielding the coating closest to the target coating is provided to the color matcher who can choose to adjust it or not to obtain the best match. In an embodiment of the method, messages are sent to the color matcher through an interface program which help to better adjust the formula.

The present disclosure also provides a system comprising:
a database comprising texture attributes and reflectance curves and CIELab values of a plurality of known coatings; and
a processor programmed for communication with the database, the processor programmed for:
obtaining multiple images each at a different angle with respect to a surface of a target coating,
performing, in operative association with at least one filtering technique, an image analysis of the obtained images to determine at least one sparkle point within the images,
performing, using the processor, a texture analysis to determine texture attributes of the target coating;
generating, using the processor and in association with the determined texture attributes, a coating formulation that yields a coating which is, to the eye of a human observer, identical or substantially similar in appearance to the target coating;
characterized in that the texture attributes comprise a contrast, a sparkle intensity, a sparkle quantity and a sparkle size of the target coating.

The terms “sparkling dot” and “sparkle point” are used synonymously. The data base may be a formulation database which comprises formulas for coating compositions and interrelated texture attributes, reflectance curves and CIELab values.

In an embodiment of the system, the images obtained are RGB images and comprise images of the surface illuminated by direct light and images of the surface illuminated by diffuse light; and the image analysis comprises conversion of the RGB images into XYZ images; and analysis of the Y component of the XYZ images to determine at least one sparkle point within the images; and wherein the filtering technique includes applying a high-pass filter to the Y component of the XYZ images, the high-pass filter having a threshold which corresponds to the contrast sensitivity and the power of discernibility of the human eye.

In a further embodiment of the system, the processor is programmed for comparing the texture attributes of the target coating to the texture attributes of the known coatings stored in the database, and for searching for a closest match.

In a further embodiment of the system, the processor is programmed for comparing reflectance curves of the target coating to reflectance curves of the known coatings stored in the database, and for searching for a closest match.

In a further embodiment of the system, the processor is programmed for comparing CIELab values of the target coating to CIELab values of the known coatings stored in the database, and for searching for a closest match.

Generally, at least the image capturing device, the color measuring device, particularly the spectrophotometer, the computer processor, the filtering technique and the formulation database are networked among each other via respective communicative connections. Each of the communicative connections between the different components of the system may be a direct connection or an indirect connection, respectively. Each communicative connection may be a wired or a wireless connection. Every suitable communication technology may be used. The formulation database, the color measuring device, the computing device, i. e. the processor, the image capturing device, and the filtering technique each may include one or more communications interfaces for communicating with each other. Such communication may be executed using a wired data transmission protocol, such as fiber distributed data interface (FDDI), digital subscriber line (DSL), Ethernet, asynchronous transfer mode (ATM), or any other wired transmission protocol. Alternatively, the communication may be wirelessly via wireless communication networks using any of a variety of protocols, such as General Packet Radio Service (GPRS), Universal Mobile Telecommunications System (UMTS), Code Division Multiple Access (CDMA), Long Term Evolution (LTE), wireless Universal Serial Bus (USB), and/or any other wireless protocol. The respective communication may be a combination of a wireless and a wired communication.

The computing device, i.e. the computer processor may include or may be in communication with one or more input devices, such as a touch screen, an audio input, a movement input, a mouse, a keypad input and/or the like. Further the computing device, i.e. the computer processor may include or may be in communication with one or more output devices, such as an audio output, a video output, screen/display output, and/or the like.

Embodiments of the invention may be used with or incorporated in a computer system that may be a standalone unit or include one or more remote terminals or devices in communication with a central computer, located, for example, in a cloud, via a network such as, for example, the Internet or an intranet. As such, the computing device described herein and related components may be a portion of a local computer system or a remote computer or an online system or a combination thereof. The formulation database and software described herein may be stored in computer internal memory or in a non-transitory computer readable medium.

The present disclosure also provides a non-transitory computer readable medium comprising software for causing a processor to:
obtain multiple images each at a different angle with respect to a surface of a target coating;
perform, in operative association with at least one filtering technique, an image analysis on the obtained images to determine at least one sparkle point within the images;
perform a texture analysis to determine texture attributes associated with the target coating; and
generate, in association with the determined texture attributes, a coating formulation that yields a coating which is, to the eye of a human observer, identical or substantially similar in appearance to the target coating;
characterized in that the texture attributes comprise a contrast, a sparkle intensity, a sparkle quantity and a sparkle size of the target coating.

In an embodiment of the non-transitory computer readable medium, the software causes the processor to convert RGB images obtained into XYZ images; and to apply a high-pass filter to the Y component of the XYZ images, the high-pass filter having a threshold which corresponds to the contrast sensitivity and the power of discernibility of the human eye.

The subject matter of the present disclosure is further described and explained with reference to the accompanying drawings.

### DETAILED DESCRIPTION OF THE DRAWINGS

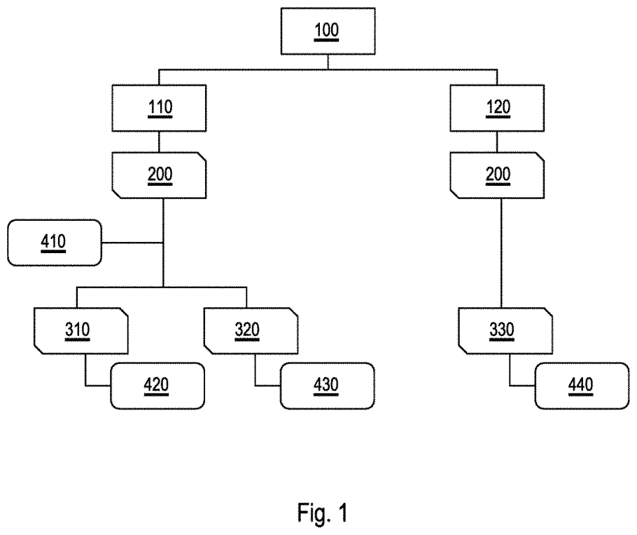

FIG. 1 is a diagram illustrating the determination of texture attributes of a target coating from images of the coating according to an embodiment of the method of the present disclosure. Multiple images 100 of the surface of a target coating are obtained using an image capturing device. Each image is obtained at a different angle with respect to a surface of the target coating. The images comprise images of the surface of the target coating illuminated by direct light 120 (Direct image) and images of the surface of the target coating illuminated by diffuse light 110 (Diffuse image). The images 110, 120 are analysed to identify sparkle points of the coating. A high-pass filter having a threshold 200 which corresponds to the contrast sensitivity and the power of discernibility of the human eye is used in the image analysis. A contrast coefficient 410 is determined from a Diffuse image 110. The image analysis of the Diffuse image 110 also allows for determining 310 the quantity of sparkle points and to obtain a sparkle quantity coefficient 420; and for determining 320 the size of sparkle points (Area of bright pixels) and to obtain a sparkle size coefficient 430. The image analysis of the Direct images 120 allows for determining 330 the sparkle intensity and to obtain a sparkle intensity coefficient 440.

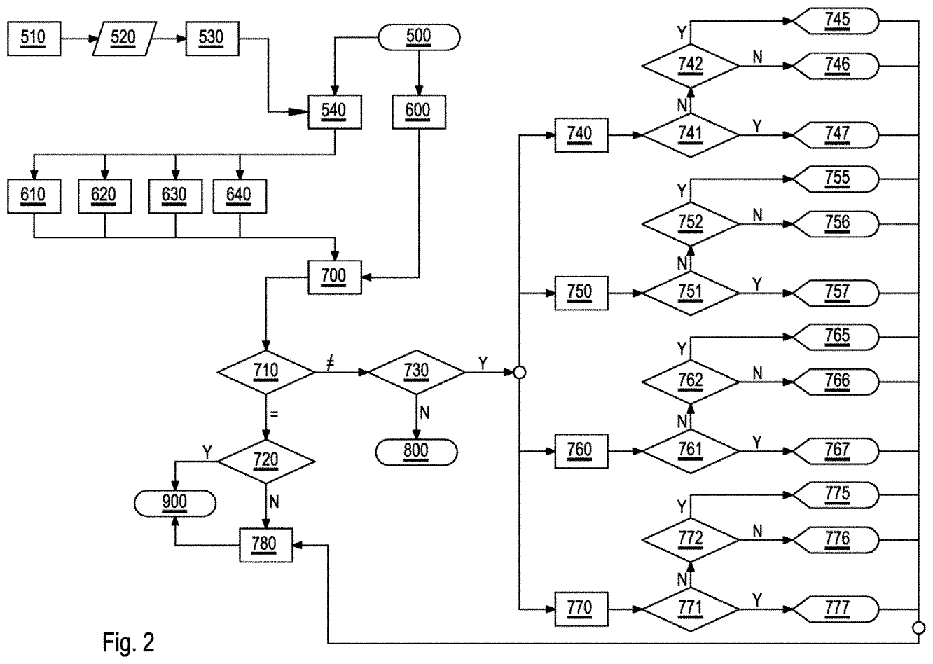

FIG. 2 is a flow chart of an embodiment of the method of the present disclosure. The method starts with a standard measurement 500 of a target coating. The measurement is performed using an image capturing device equipped with a spectrophotometer, e.g., a device as described in EP 2 728 342 B1. CIELab values and reflectance curves 600 of the target coating are measured using the device. Image analysis of RGB images of the target coating surface obtained at different angles both with direct and with diffuse illumination allows for the determination of four texture attributes of the target coating: contrast 610, sparkle intensity 620, sparkle quantity 630, and sparkle size 640. In the image analysis, a high-pass filter is applied 540 to the image data. The threshold value 530 used corresponds to the sensitivity and the power of discernibility of the human eye, and has been determined by visual assessment 510 of a multitude of coatings by trained observers using expert knowledge 520.

CIELab values and reflectance curves 600 as well as the texture attributes 610, 620, 630, 640 determined are used to search 700 for a matching coating composition in a database comprising data on a multitude of known coating compositions. If a composition 710 is found with matching texture attributes and matching colorimetric values, a check 720 is performed, whether or not the composition represents the closest formulation. If this is the case, the best match 900 has been found. If not, then the formulation is adjusted 780 with proposals from a user to arrive at the best match.

If a composition is found for which not all texture attributes and colorimetric values match, a check 730 is performed, whether or not the colorimetric values of the composition match. If this is not the case, development of a matching formulation is begun anew 800 (“start from scratch”). If the colorimetric values match, a check is performed, whether or not the texture parameters of the composition match. The value of each texture parameter, i.e., sparkle size 740, sparkle intensity 750, sparkle quantity 760, and contrast 770, of the coating obtained from the proposed composition is determined and compared 741, 751, 761, 771 to the corresponding value of the target coating. For each texture parameter, information generated from the result of the comparison is transmitted to a user.

If the value of the respective texture parameter of the coating obtained from the proposed composition matches 747, 757, 767, 777 the corresponding value of the target coating, the user is informed that the respective parameter matches and no change is necessary.

If the result of the check 742 is that sparkle size of the target is larger than that of the proposed composition, a proposal 745 to adjust the composition and substitute the pigments in the composition by coarser pigments is transmitted to the user. If the sparkle size is smaller, a proposal 746 to adjust the composition and substitute the pigments in the composition by smaller pigments is transmitted to the user.

If the result of the check 752 is that the sparkle intensity of the target is larger than that of the coating obtained from the proposed composition, a proposal 755 to adjust the composition and substitute the pigments in the composition by pigments with more sparkle intensity is transmitted to the user. If the sparkle intensity is smaller, a proposal 756 to adjust the composition and substitute the pigments in the composition by pigments with less sparkle intensity is transmitted to the user.

If the result of the check 762 is that the sparkle quantity of the target is larger than that of the coating obtained from the proposed composition, a proposal 765 to adjust the composition and increase the quantity of effect pigments in the composition is transmitted to the user. If the sparkle quantity is smaller, a proposal 766 to adjust the composition and decrease the quantity of effect pigments in the composition is transmitted to the user.

If the result of the check 772 is that the contrast value of the target is larger than that of the coating obtained from the proposed composition, a proposal 775 to adjust the composition and increase the contrast value is transmitted to the user. If the contrast value is smaller, a proposal 776 to adjust the composition and decrease the contrast value is transmitted to the user. The contrast value can be modified by changing the background color (a darker background will increase the contrast perception and vice versa) or by changing the particles (smaller particles will tend to a lower contrast as it is less easy to see them).

The method interfaces with a user 780 to transmit the information on the texture parameters. Based on this information, the user adjusts the composition of the effect pigments in the formulation to arrive at the best match 900.

### LIST OF REFERENCE SIGNS

100 Pictures

110 Diffuse

120 Direct

200 Threshold based on contrast

310 Quantity of bright pixels

320 Area of bright pixels

330 Intensity of bright pixels

410 Contrast coefficient

420 Sparkle quantity coefficient

430 Sparkle size coefficient

440 Sparkle intensity coefficient

500 Standard measurement

510 Visual assessment

520 Expert knowledge

530 Adaptive threshold

540 Apply threshold on pictures

600 CIELab values and reflectance curves

610 Contrast determination

620 Sparkle intensity determination

630 Sparkle quantity determination

640 Sparkle size determination

700 Search in database

710 Comparison of texture parameters and colorimetric values

720 Closest formula?

730 Colorimetric values ok?

740 Sparkle size determination

741 Sparkle size of target=proposal?

742 Sparkle size of target>proposal?

745 Exchange for coarser pigments

746 Exchange for smaller pigments

747 Sparkle size of proposed formulation matches target value

750 Sparkle intensity determination

751 Sparkle intensity of target=proposal?

752 Sparkle intensity of target>proposal?

755 Exchange for pigments more sparkle intensity

756 Exchange for pigments with less sparkle intensity

757 Sparkle intensity of proposed formulation matches target value

760 Sparkle quantity determination

761 Sparkle quantity of target=proposal?

762 Sparkle quantity of target>proposal?

765 Increase quantity of effect pigments

766 Decrease quantity of effect pigments

767 Sparkle quantity of proposed formulation matches target value

770 Contrast determination

771 Contrast of target=proposal?

772 Contrast of target>proposal?

775 Increase contrast

776 Decrease contrast

777 Contrast of proposed formulation matches target value

780 Interface with user to adjust composition of formulation

800 Start from scratch

900 Best match

1. A computer-implemented method, comprising:
obtaining, using an image capturing device, multiple images, each obtained at a different angle with respect to a surface of a target coating, wherein the images obtained are RGB images and comprise images of the surface illuminated by direct light and images of the surface illuminated by diffuse light;
obtaining, using a spectrophotometer, multiple reflectance curves, each obtained at a different angle with respect to the surface of the target coating;
obtaining CIELab coordinates of the target coating;
performing, using an electronic computer processor in operative association with at least one filtering technique, an image analysis of the obtained images to determine at least one sparkle point within the images;
performing, using the processor, a texture attribute analysis to determine texture attributes of the target coating from the at least one sparkle point determined within the images; and
generating, using the processor, a coating formulation that yields a coating which is, to the eye of a human observer, identical or substantially similar in appearance to the target coating
characterized in that
the image analysis comprises conversion of the RGB images into XYZ images and analysis of the Y component of the XYZ images;
the texture attributes comprise contrast between the sparkle points and the masstone color of the target coating, intensity of the sparkle points, quantity of the sparkle points, and size of the sparkle points of the target coating;
the texture attributes of the target coating are compared, using the processor, to the texture attributes of a plurality of known coatings stored in a database, the reflectance curves of the target coating are compared, using the processor, to the reflectance curves of a plurality of known coatings stored in the database, the CIELab values of the target coating are compared, using the processor, to the CIELab values of a plurality of known coatings stored in the database, and a closest match coating is searched in the database, using the processor; and
the coating formulation that yields a coating which is, to the eye of a human observer, identical or substantially similar in appearance to the target coating, is generated in association with the determined texture attributes and the closest match coating found in the database.

2. The method of claim 1, wherein the filtering technique includes applying a high-pass filter to the Y component of the XYZ images, the high pass filter having a threshold which corresponds to the contrast sensitivity and the power of discernibility of the human eye, the threshold value being determined from a comparison of visual assessments of coatings samples by trained observers.

3. The method of claim 1, wherein a contrast coefficient C is determined by image analysis of the surface of the target coating illuminated by diffuse light.

4. The method of claim 3, wherein the contrast coefficient C corresponds to the formula
$$C = \frac{log ( \frac{{MEAN}_{FG} / {MEAN}_{BG}}{\vert log ( {WS}_{FG} / {WS}_{BG} ) \vert} )}{\sqrt{MAX - MIN}}$$

5. The method of claim 1, wherein a sparkle size coefficient S is determined using the formula
$$S = ( \frac{\sqrt{MEAN}}{{{SLOPE}_{2}}^{2}} )$$

6. The method of claim 1, wherein a sparkle quantity coefficient Q, is determined using the formula
$$Q = \sqrt{\frac{Number of pixels in the foreground}{ln ( S )}}$$

7. The method of claim 1, wherein a sparkle intensity coefficient I is determined using the formula
$$I = log ( \frac{\sqrt{MAX - MIN}}{MEAN} \times {MEAN}_{FG} \times {ln ( S )}^{2} )$$

8. A system comprising:
a database comprising texture attributes and reflectance curves and CIELab values of a plurality of known coatings; and
a processor programmed for communication with the database, the processor programmed for:
obtaining multiple images each at a different angle with respect to a surface of a target coating, wherein the images obtained are RGB images and comprise images of the surface illuminated by direct light and images of the surface illuminated by diffuse light,
obtaining multiple reflectance curves, each obtained at a different angle with respect to the surface of the target coating;
obtaining CIELab coordinates of the target coating;
performing, in operative association with at least one filtering technique, an image analysis of the obtained images comprising conversion of the RGB images into XYZ images and analysis of the Y component of the XYZ images to determine at least one sparkle point within the images,
performing, using the processor, a texture analysis to determine texture attributes of the target coating from the at least one sparkle point determined within the images, the texture attributes comprising contrast between the sparkle points and the masstone color of the target coating, intensity of the sparkle points, quantity of the sparkle points, and size of the sparkle points of the target coating;
comparing, using the processor, the texture attributes of the target coating to the texture attributes of the plurality of known coatings stored in the database, the reflectance curves of the target coating to the reflectance curves of the plurality of known coatings stored in the database, the CIELab values of the target coating to the CIELab values of the plurality of known coatings stored in the database, and searching for a closest match;
generating, using the processor and in association with the determined texture attributes and the closest match coating found in the database, a coating formulation that yields a coating which is, to the eye of a human observer, identical or substantially similar in appearance to the target coating.

9. The system of claim 8, wherein the filtering technique includes applying a high-pass filter to the Y component of the XYZ images, the high pass filter having a threshold which corresponds to the contrast sensitivity and the power of discernibility of the human eye, the threshold value being determined from a comparison of visual assessments of coatings samples by trained observers.

10. A non-transitory computer readable medium comprising software for causing a processor to:
obtain multiple images, each at a different angle with respect to a surface of a target coating;
obtain multiple reflectance curves, each obtained at a different angle with respect to the surface of the target coating;
obtain CIELab coordinates of the target coating;
perform, in operative association with at least one filtering technique, an image analysis on the obtained images to determine at least one sparkle point within the images;
perform a texture analysis to determine texture attributes associated with the target coating from the at least one sparkle point determined within the images; and
generate, in association with the determined texture attributes, a coating formulation that yields a coating which is, to the eye of a human observer, identical or substantially similar in appearance to the target coating;
characterized in that
the image analysis comprises conversion of the RGB images into XYZ images and analysis of the Y component of the XYZ images;
the texture attributes comprise contrast between the sparkle points and the masstone color of the target coating, intensity of the sparkle points, quantity of the sparkle points and size of the sparkle points of the target coating;
the processor is caused to compare the texture attributes of the target coating to the texture attributes of a plurality of known coatings stored in a database, compare the reflectance curves of the target coating to the reflectance curves of a plurality of known coatings stored in the database, compare the CIELab values of the target coating to the CIELab values of a plurality of known coatings stored in the database, and search a closest match coating in the database; and
the coating formulation that yields a coating which is, to the eye of a human observer, identical or substantially similar in appearance to the target coating, is generated in association with the determined texture attributes and the closest match coating found in the database.

11. The non-transitory computer readable medium of claim 10, wherein the software causes the processor to apply a high-pass filter to the Y component of the XYZ images, the high pass filter having a threshold which corresponds to the contrast sensitivity and the power of discernibility of the human eye, the threshold value being determined from a comparison of visual assessments of coatings samples by trained observers.
